(19) United States
(12) Patent Application Publication
(10) Pub. No.: US 2009/0222874 A1
(43) Pub. Date: Sep. 3, 2009

(54) METHOD, DEVICE AND SYSTEM FOR SESSION MOBILITY OF INTERNET PROTOCOL TELEVISION (IPTV) CONTENT BETWEEN END USER COMMUNICATION DEVICES

(75) Inventors: Richard E. White, Cary, IL (US); James A. Marocchi, Winfield, IL (US)

Correspondence Address: Motorola, Inc.;Law Department, 1303 East Algonquin Road, 3rd Floor, Schaumburg, IL, 60196, US

(73) Assignee: MOTOROLA, INC., SCHAUMBURG, IL (US)

(21) Appl. No.: 12/039,821

(22) Filed: Feb. 29, 2008

(51) Int. Cl. H04N 7/173

(52) U.S. Cl. 725/118; 725/114

(57) ABSTRACT

A method, device and system for providing Internet Protocol Television (IPTV) session mobility between end user communication devices, such as between a set-top box and a mobile communication device. IPTV session mobility is provided using a control server configured to manage and facilitate the transfer of the IPTV session in response to receiving appropriate IPTV session control information from the set-top box and/or the mobile communication device. The control server also is configured to discontinue or terminate an existing transfer of IPTV content to the mobile communication device in response to receiving appropriate IPTV session control information. The control server also is configured to allow the mobile communication device to change IPTV channels, perform trick play operations and retrieve stored content from and control various functions of the set-top box. The control server can be a network element coupled to the IP network.

### BACKGROUND OF THE INVENTION

1. Field of the Invention

The invention relates to providing Internet Protocol Television (IPTV) content to end user communication devices, including mobile communication devices. More particularly, the invention relates to providing session mobility of the delivery of IPTV content between end user communication devices, including set-top boxes and mobile end user communication devices.

2. Description of the Related Art

There are several methods of delivering multimedia content to an end user, whether to a multimedia content processing device at the home of the end user, such as a set-top box, or to a mobile device in the possession of a mobile user. Some multimedia content processing devices can be configured with the ability to perform place shifting, which allows end users to watch video content televised or received in a first location from a second location. Alternatively, a place shifting device can be connected to a conventional multimedia content processing device and to a broadband network to allow an end user to watch current video content (e.g., live television broadcasts) or multimedia content stored in the multimedia content processing device from any location that has a connection to the broadband network. Some place shifting devices also allow a mobile device to access and view current and/or stored video content received by an end user's multimedia content processing device.

However, there are several possible problems with conventional methods for allowing a mobile user to access video content delivered to an end user's set-top box. For example, conventional multimedia content processing devices of this kind are not specifically designed for the delivery of video content to mobile video devices. Also, such multimedia content processing devices use the broadband connection to the set-top box to distribute video content to the mobile device, which can result in increased set-top box usage to the point of making the set-top box a bandwidth bottleneck. Also, such configuration ties up the video source in end user home (e.g., the set-top box location) when the mobile device is receiving video content. Moreover, such multimedia content processing devices typically require an in-home setup and are single user only, and therefore are not particularly well-suited for broadcast content.

Another conventional approach for allowing a mobile user to access video content delivered to an end user's set-top box is the use of a set-top box or other multimedia content processing device that is modified or configured to distribute video content to a mobile device. However, a broadband uplink connection from the set-top box is required to distribute video content to the mobile device. Such connection can be a bandwidth bottleneck for the video processing device.

Yet another conventional approach to delivering multimedia content including video content to mobile end users is through the use of mobile communication or video devices configured according to the Digital Video Broadcasting-Handheld (DVB-H) standard or specification. DVB-H devices currently are capable of receiving various multimedia content, including video broadcasts from suitable content sources, such as over-the-air broadcasters, a cable television plant, a satellite service provider or other multimedia service provider. DVB-H devices can receive multimedia content using a cellular network or a wireless access network. However, there is no interaction or means of interaction between the DVB-H device and the end user set-top box, thus there is no possibility of session mobility between the set-top box and the mobile device.

Presently, Internet Protocol Television (IPTV) video content can be delivered by an appropriate IPTV content provider to an end user home via the end user's set-top box, using an IP network and appropriate connection between the set-top box and the IP network. In the future, content providers likely will want to deliver IPTV content to mobile communication devices. Moreover, content providers also will want end users to be able to transfer IPTV content sessions between the end user's home set-top box and the end user's mobile communication device, i.e., IPTV session mobility between the end user's home set-top box and mobile communication device.

### BRIEF DESCRIPTION OF THE DRAWINGS

FIG. 1 is a block diagram of a communication system used for providing session mobility of IPTV content to an end user communication device, such as a mobile communication device, from another end user communication device, such as a set-top box or other multimedia content processing device;

FIG. 2 is a block diagram of a control server or session controller device for providing session mobility of IPTV content from one end user communication device, such as a set-top box, to another end user communication device, such as a mobile communication device;

FIG. 3 is a flow diagram of an IPTV session transfer from an end user communication device, such as a set-top box or other multimedia content processing device, to a mobile communication device, in which the IPTV session transfer is initiated by the end user communication device;

FIG. 4 is a flow diagram of an IPTV session transfer from an end user communication device, such as a set-top box or other multimedia content processing device, to a mobile end user communication device, in which the IPTV session transfer is initiated by the mobile communication device;

FIG. 5 is a flow diagram of an IPTV session transfer from a mobile communication device to an end user communication device, such as a set-top box or other multimedia content processing device;

FIG. 6 is a flow diagram of an IPTV session change, i.e., a channel change, for a mobile communication device;

FIG. 7 is a flow diagram of the retrieval of stored IPTV content from an end user communication device, such as a set-top box or other multimedia content processing device, to a mobile communication device;

FIG. 8 is a flow diagram of the use of trick play on IPTV content delivered to a mobile communication device;

FIG. 9 is a flow diagram of the control of the functionality of an end user communication device, such as a set-top box or other multimedia content processing device, by a mobile communication device; and

FIG. 10 is a block diagram of a method for providing session mobility of IPTV content to an end user communication device, such as a mobile communication device, from another end user communication device, such a set-top box or other multimedia content processing device.

### DETAILED DESCRIPTION

In the following description, like reference numerals indicate like components to enhance the understanding of the IPTV session mobility methods, devices and systems through the description of the drawings. Also, although specific features, configurations and arrangements are discussed herein below, it should be understood that such specificity is for illustrative purposes only. A person skilled in the relevant art will recognize that other steps, configurations and arrangements are useful without departing from the spirit and scope of the invention.

The methods, devices and systems described herein involve providing session mobility for the delivery of Internet Protocol Television (IPTV) content between end user communication devices, such as between a set-top box or other multimedia content processing device and a mobile communication device. Session mobility of IPTV content is provided by using a control server that is configured to manage and facilitate the transfer of an IPTV session between end user communication devices, e.g., between an end user's set-top box and mobile communication device. The control server is configured to transmit IPTV content from an IPTV content source to the mobile communication device in response to receiving appropriate IPTV session control information, e.g., from the multimedia content processing device and/or the mobile communication device, as needed to control and manage the transfer of the IPTV session. The control server also is configured to discontinue or terminate an existing delivery of IPTV content to the mobile communication device in response to receiving appropriate IPTV session control information. The control server is configured in such a way that IPTV content transfer can be initiated by either end user communication device, or other suitable source of IPTV session control information. The control server also is configured to allow the mobile communication device to change the “channel” of the received IPTV content, perform trick play operations on received IPTV content, retrieve stored content from the multimedia content processing device, and control various functions of the multimedia content processing device. The control server can be a network element coupled to and/or contained within the IP network that couples one or more IPTV content sources to various control points that communicate with end user communication devices, including mobile communication devices. Alternatively, the control server can be partially or completely included or contained within one or more end user communication devices and/or IPTV content sources.

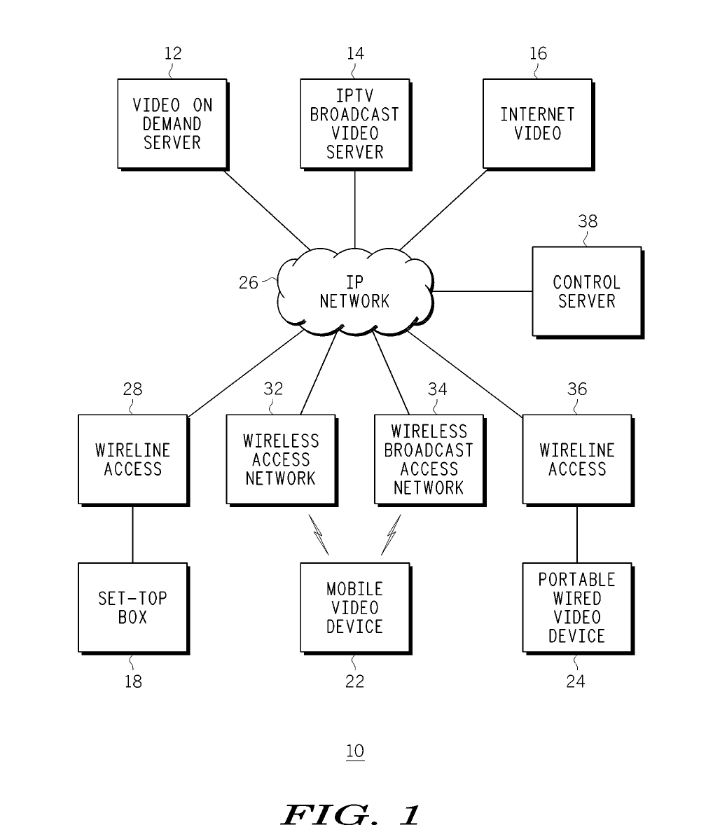

Referring to FIG. 1, shown is a block diagram of a communication system 10 for use in providing session mobility of Internet Protocol Television (IPTV) content from an end user communication device, such as a set-top box or other multimedia content processing device, to another end user communication device, such as a mobile communication device. The system 10 includes one or more sources of IPTV content, e.g., a video on demand (VOD) server 12, an IPTV broadcast video server 14, an Internet video source 16 or other suitable source for providing IPTV content. The system 10 also includes a plurality of end user communication devices, such as a set-top box 18 or other multimedia content processing device, and a mobile communication or video device 22. The system 10 also can include a portable wired video device 24 and any other end user communication device (not shown) suitable for receiving IPTV content.

The set-top box 18 is coupled to one or more of the IPTV content sources via an IP network 26, which can include or be coupled to a wireline access network and/or control point 28. The mobile communication device 22 is coupled to one or more of the IPTV content sources via the IP network 26, which can include or be coupled to a wireless access network or network control point 32 and/or a wireless broadcast network or network control point 34. The portable wired video device 24 is coupled to one or more of the IPTV content sources via the IP network 26, which can include or be coupled to a wireline access network or network control point 36. The system 10 also includes a control server or session controller 38, which can be a standalone network element coupled to and/or contained within the IP network 26 or, alternatively, can be part of the set-top box 18 and/or other suitable devices or components in the system 10, including one or more of the IPTV content sources.

IPTV or IP-based TV generally refers to the transmission of television programs from private Internet providers, such as cable and telephone companies, or from a Web site, using IP protocols over an IP network. IPTV, which also is referred to as “TV over IP,” uses streaming video techniques to deliver scheduled TV programs. Unlike transmitting over the air or via conventional cable television systems to an end user set-top box or television set, IPTV uses IP protocols as the control and delivery transport and requires an end user device, such as a set-top box 18 or mobile video device 22, to decode the images in real-time. In the IPTV system environment, the end user receives only the “channel” that the end user is viewing. IPTV also supports various interactive features. Such features include an interactive program guide, the ability to view international programming, the ability to watch a program with people that are geographically separated from you with the ability to chat with those people, multiple picture-in-picture viewing, and immediate access to products or information while viewing.

The video on demand server 12 is part of a VOD system that allows end users to select and watch stored video content over an IP network as part of an interactive television system. VOD systems are either “streaming,” in which the video content is streamed over an IP network to the end user, or “download,” in which a video content program is downloaded in its entirety to the end user device, e.g., the set-top box 18 or mobile video device 22, before viewing starts. VOD uses unicast IP protocols to deliver the video content to the end user device. VOD systems allow the end user to perform trick play operations on the video content, such as pause, fast forward, fast rewind, slow forward, slow rewind, jump to a previous video frame and/or jump to a future video frame.

The IPTV broadcast video server 14 is the portion of an IPTV distribution system that distributes IPTV “channels” to the end users, e.g., using multicast IP protocols. The IPTV distribution system includes a headend (e.g., video acquisition system and encoders), content management and digital rights management (DRM), and IP fiber backbone & edge routers. The IPTV distribution system also includes a set of protocols used for content delivery to the end user. These protocols can be open, standard, proprietary, or a combination. Typically, this system is closed and available only to subscribers.

The multicast streams delivered from the IPTV broadcast video server 14 to a set-top box 18 may be different than the multicast streams delivered from the IPTV broadcast video server 14 to a mobile video device 22. The use of different multicast streams allows the IPTV broadcast video server 14 to provide “mobile-friendly” streams to the mobile video device 22, i.e., multicast streams that are better able to be received and processed by the mobile video device 22 than multicast streams formatted for set-top boxes and other video processing communication devices.

The Internet video source 16 is any suitable source that provides Internet video content to the end users. Internet video content is considered to be any video or content delivered over the internet using IP protocols. Internet video content can range from download to streaming content. Also, Internet video content can be formatted in any suitable manner, e.g., according to a suitable standard, such as the MPEG (Moving Picture Experts Group) 2 or MPEG 4 standard. Other suitable Internet video content formats include Windows Media Video (WMV), Audio Video Interleave (AVI), and QuickTime multimedia format (mov). Internet video also can include raw digital video. Any server on the Internet can supply the video content. Most Internet video systems are open and available to anyone with an Internet connection, although some Internet video systems may require membership or user login.

The set-top box 18 is a multimedia content processing device or other end user communication device that “sits on top” of an end user's television or other display device. The set-top box 18 receives IPTV content and decodes the IPTV content in real-time for viewing on the television. The set-top box 18 allows end users to view IPTV or VOD programming content, as well as video content from the Internet or local IP networks, i.e., IPTV content from any one or more of the IPTV content sources 12, 14, 16. The set-top box 18 typically has the capability of storing IPTV content for later viewing. The set-top box 18 typically is connected to the IP network 26 via the wireline access network 28 or other suitable network or control point.

In general, for purposes of discussion herein, the set-top box 18 can be any suitable IPTV content processing device. The set-top box 18 can be partially or completely any suitable device or subsystem (or portion thereof) for receiving IPTV content, storing the received IPTV content, processing and/or decoding the received IPTV content, and transmitting or transferring the processed IPTV content to an end user display device (not shown), such as a television, a computer monitor or other suitable display device. The display device can be a separate component from the set-top box 18 or, alternatively, the set-top box 18 and the display device can be combined or integrated as a single component.

For example, the set-top box 18 can be any digital video recorder (DVR) or digital video server (DVS) device, including any signal converter or decoder component with internal and/or external recording capabilities and local and/or remote storage, which often are referred to as personal video recorder (PVR) devices. Other suitable end user communication devices or multimedia content processing devices include a residential gateway, a home media server system, a digital video disk recorder, a computer, a television with built-in or added-on multimedia content receiving and/or storing capability, and/or other suitable computing devices or multimedia content devices, including internet protocol (IP), satellite and cable digital video recorders, and home area network (HAN) devices and systems.

The wireline access network 28 can be any suitable device and/or network component or components for routing IPTV content between the set-top box 18 and the IP network 26. Similarly, the wireline access network 36 can be any suitable device and/or network component or components for routing IPTV content between the portable wired video device 24 and the IP network 26. All or a portion of one or more of the wireline access network 28, 36 can be part of a residential gateway or a home media server system that includes the respective end user communication device 18, 24. Alternatively, all or a portion of one or more of the wireline access network 28, 36 and/or its functionality can be incorporated into or contained within the respective end user communication device 18, 24.

The mobile communication or video device 22 is any suitable device that has connectivity to a wireless wide area broadband data network, such as via WiMAX (Worldwide Interoperability for Microwave Access), Ev-Do (Evolution-Data Optimized), or HSxPA (High Speed Packet Access). The mobile video device 22 is capable of receiving IPTV content in the form of data packets via the wireless data network and decoding and displaying the data packets on a built-in display. The mobile video device 22 also is capable of accessing an Electronic Program Guide (EPG) for determining available IPTV content. The selection of IPTV content is similar to that of the set-top box 18.

For example, the mobile communication device 22 can be any suitable mobile or cellular telephone, smartphone, personal digital assistant (PDA) device or other wireless handheld device with such capability, including a Digital Video Broadcasting-Handheld (DVB-H) mobile communication device. The communication device 22 also can be any suitable digital camera with such capability, a laptop personal computer (PC) or a notebook PC. The mobile video device 22 typically is connected to the IP network 26 via the wireless access network 32 and/or the wireless broadcast network 34. As will be discussed in greater detail hereinbelow, the mobile video device 22 also can interact with the end user's set-top box 18 via the control server 38.

The portable wired device 24 is any suitable portable device that has connectivity to a wired wide area broadband data network, such as the Internet. The portable wired device 24 is capable of receiving IPTV content in the form of data packets via the wired data network and decoding and displaying the data packets on a built-in display. The portable wired device 24 also is capable of accessing an EPG for determining what IPTV content is available. The selection of available IPTV content is similar to that of the set-top box 18. The portable wired device 24 also can interact with the set-top box 18 via the control server 38.

One or more of the IP network 26, the wireline access network or control point 28, the wireless access network or network control point 32, the wireless broadcast network or network control point 34, and the wireline access network or network control point 36 can be any communication network, network server arrangement or IP distribution system suitable for coupling directly or indirectly to any one or more of the IPTV content sources, the end user communication devices, and/or the control server 38. For example, all or a portion of the IP network 26, the wireline access network or control point 28, the wireless access network or network control point 32, the wireless broadcast network or network control point 34, and the wireline access network or network control point 36 can be the Internet or an Internet protocol (IP) based network, a computer network, a web-based network or other suitable network system. Also, at least a portion of the IP network 26, the wireline access network or control point 28, the wireless access network or network control point 32, the wireless broadcast network or network control point 34, and the wireline access network or network control point 36 can be any wired or wireless wide area network (WAN), local area network (LAN) or wireless local area network (WLAN), such as a residential network.

One or more of the IPTV content sources, the end user communication devices, and/or the control server 38 can be coupled to one or more of the IP network 26, the wireline access network or control point 28, the wireless access network or network control point 32, the wireless broadcast network or network control point 34, and the wireline access network or network control point 36 via any suitable connection or connections, e.g., one or more coaxial cables and/or optical fibers, including a Hybrid Fiber Coaxial (HFC) cable system. Other suitable connections include Fiber To The Premises (FTTP) systems, such as Fiber To The Curb (FTTC) or Fiber To The Home (FTTH), or over any suitable number of digital subscriber line systems (xDSL). Also, IPTV content can be provided wirelessly, e.g., via over-the-air-broadcast from a satellite service provider or other suitable content service provider. The wireline access network 28 is made available typically by the end user's telephone company or cable television company. The wireless access network 32 and the wireless broadcast network 34 typically are made available by the end user's a wireless service provider.

The control server or session controller 38 includes the collection of functions used to support the delivery of IPTV content to an end user communication device, such as the mobile video device 22, over various wireline and/or wireless access networks. The control server 38, which also can be referred to as the mobile video function (MVF), receives multicast streams of IPTV content from the broadcast video server 14 or other IPTV content source. The control server 38 also facilitates the interaction between end user communication devices, such as between the mobile video device 22 and the set-top box 18, as will be discussed in greater detail hereinbelow.

The control server 38 can be partially or completely any suitable network element, device or subsystem (or portion thereof) configured for receiving IPTV content from one or more IPTV content sources, storing the received IPTV content, processing or decoding the received IPTV content, and transmitting or transferring the processed IPTV content to the mobile video device 22, e.g., via the IP network 26 and one or more of the wireless access network or network control point 32 and/or the wireless broadcast network or network control point 34, or the set-top box 18 (or other end user communication device), e.g., via the IP network 26 and one or more of the wireline access network or network control points 28, 36. Also, the control server 38 can be partially or completely any suitable network element, device or subsystem (or portion thereof) configured for receiving IPTV session control information from one or more of the set-top box 18, the mobile video device 22 or other suitable end user communication device. As will be discussed in greater detail hereinbelow, IPTV session control information generally includes information that the control server 38 uses to manage, control and facilitate the transmission or transfer of IPTV content or an IPTV session between end user communication devices, such as between the set-top box 18 and the mobile video device 22.

As discussed hereinabove, the control server 38 can be a network element or device coupled to and/or contained within one or more of the IP network 26, the wireline access network or network control point 28, the wireline access network 36 or network control point, the wireless access network or network control point 32 and/or the wireless broadcast network or network control point 34. Alternatively, the control server 38 can be partially or completely packaged, stored, built or otherwise contained on or within one or more of the set-top box 18, one or more of the IPTV content sources 12, 14, 16, the IP network 26, the wireline access network or network control point 28, the wireline access network or network control point 36, the wireless access network or network control point 32 and/or the wireless broadcast network or network control point 34.

As will be discussed in greater detail hereinbelow, the control server 38 controls, coordinates and provides the functionality to allow IPTV content session mobility or transfer between end user communication devices, such as between a home device (e.g., the set-top box 18) and a mobile device (e.g., the mobile video device 22) in a centralized network-based solution. The control server 38 also is configured to separate the delivery of IPTV content between end user communication devices (e.g., between the home device and the mobile device) so that the first end user communication device (e.g., the home device) is not involved in the actual IPTV content delivery to the second end user communication device (e.g., the mobile device). Such separation provides much more efficient delivery of the IPTV content than conventional arrangements and systems. Also, the IP connection to the first device, e.g., the home device, is not used to deliver the IPTV content to the second device, e.g., the mobile device. Moreover, the control server 38 also provides flexibility for the end user to control the nature of the IPTV session transfer, e.g., pausing the transferred IPTV content or viewing the IPTV content at the real time point after transfer. The control server 38 and its functionality can be used in any system that supports IPTV content delivery to more than one end user communication device, e.g., the set-top box 18 and the mobile video device 22.

An IPTV session or IPTV content session is an IPTV content “channel” that currently is being viewed by an end user, e.g., via the set-top box 18 (and display device) or the mobile video device 22. The IPTV session is a stream of IP packets from the IPTV broadcast video server 14, or other suitable IPTV content source. When the end user changes “channels,” the IPTV session is changed. An IPTV session transfer involves the moving of an IPTV session from one end user communication device to another end user communication device, e.g., from the set-top box 18 to the mobile video device 22, and may involve moving or transferring the IPTV session from one access network to another access network. More specifically, an IPTV session transfer involves discontinuing (at least temporarily) a first IPTV session from an IPTV content source to a first end user communication device and establishing a second IPTV session (at least temporarily) from the IPTV source to a second end user communication device. As discussed hereinabove, the delivery of IPTV content to end user communication devices is separate, i.e., the first end user communication device is not involved in the delivery of IPTV content to the second end user communication device. The control server 38 coordinates and controls the IPTV content delivery associated with such IP session transfer.

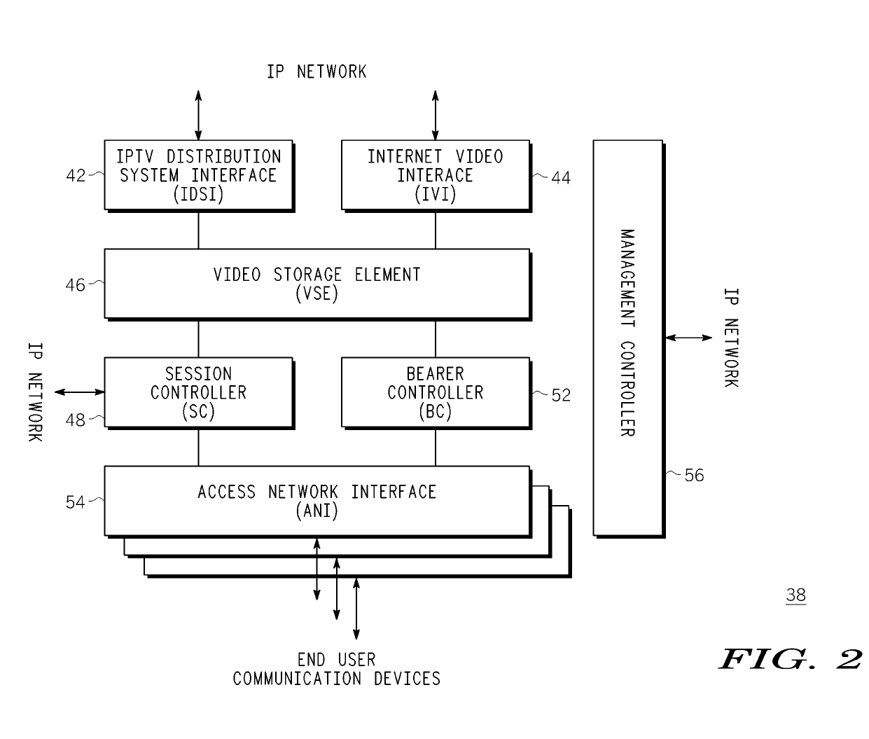

Referring now to FIG. 2, with continuing reference to FIG. 1, shown is a block diagram of the control server or session controller 38 for providing IPTV session mobility between end user communication devices, such as between the set-top box 18 and the mobile communication device 22. The control server 38 includes an IPTV distribution system interface (IDSI) 42, an Internet video interface (IVI) 44, an IPTV content video storage (VS) element 46, a session controller (SC) 48, a bearer controller (BC) 52, one or more access network interfaces (ANI) 54 and a management controller 56.

The IPTV distribution system interface (IDSI) 42 is responsible for interfacing with the IPTV distribution system, e.g., via the IP network 26. The IDSI 42 handles the receipt of all IPTV content and control information to the control server 38, and forwards the content streams to the video storage element 46. The IDSI 42 also is coupled to and interfaces with the session controller 48, which controls the operation of the IDSI 42.

In general, the IDSI 42 looks like the IPTV interface into a services edge router. The IDSI 42 also provides any protocol interworking between the other components of the control server 38 and the IPTV distribution system. Since all IPTV distribution systems are not the same, the IDSI 42 is configured to support the protocols of the particular system that is providing the IPTV content. In most cases, a single interface will be used for a given IPTV distribution system.

The IDSI 42 serves as a protocol interface to the IPTV distribution system, e.g., from the IPTV broadcast video server via the IP network 26. The protocol interface function includes the identification of each of the IPTV streams and corresponding protocol support required by the distribution system. Each distribution system will use a defined set of protocols.

The IDSI 42 also serves to forward received IPTV streams to the video storage element 46. Such forwarding can be on a per user basis. Alternatively, all IPTV streams can be forwarded to the video storage element 46 for storage. As will be discussed in greater detail hereinbelow, such storage determination is made by the session controller 48.

The IDSI 42 also serves to provide protocol interworking between the IPTV distribution system and other components within the control server 38. The IDSI 42 seeks to have a defined set of protocols for use in communicating between the various components of the control server 38. In this manner, the IDSI 42 may provide interworking between protocols used in the control server 38 and another protocol interworking for the interface to the IPTV distribution system.

The Internet video interface (IVI) 44 is responsible for interfacing with IPTV content servers on the Internet, such as the Internet video source 16. The IPTV video content can be sourced from varying types of services, such as one or more content web sites, a television network, or any suitable server that can stream IPTV video content. Typically, such video streams are formatted according to a suitable streaming protocol, such as Windows Media, Real, or QuickTime. The IVI 44 provides access to the IPTV video stream and forwards the stream to the video storage element 46. All streams can be forward or, alternatively, such forwarding can be on a per user basis. As will be discussed in greater detail hereinbelow, such storage determination is made by the session controller 48.

The IVI 44 also provides an interface to the stored content on an end user's set-top box 18 or other end user communication device. Such interface allows the end user to examine the content stored on the set-top box 18 and, if desired, initiate a transfer of stored content from the set-top box 18 to the control server 38. The IVI 44 is configured to forward such transferred content to the video storage element 46.

The IVI 44 also serves to identify and provide protocol interworking between various IPTV content sources and the other components within the control server 38. The IVI 44 seeks to have a defined set of protocols for use in communicating between the various components of the control server 38. In this manner, the IDSI 42 may provide interworking between protocols used in the control server 38 and another protocol interworking for the interface to the IPTV distribution system and various IPTV content sources therein.

The video storage element 46 is responsible for the storage of IPTV video content on behalf of the end user. As just discussed, IPTV video content is supplied to the control server 38 via the IDSI 42 and the IVI 44. The IPTV video content is stored, in any suitable format, on a per user basis or, alternatively, on a per stream basis. Content storage is controlled by the session controller 48, which is coupled to the video storage element 46. The retrieval of the stored content from the video storage element 46 is controlled by the session controller 48 and the bearer controller 52. The stored content is sent to the bearer controller 52 on a per user basis or, alternatively, on a per stream basis. The “per stream” basis is much like a broadcast stream. In this manner, the video storage element 46 acts much like a network DVR.

The session controller (SC) 48 is a central control point responsible for the setup, termination and control of an IPTV session, as well as the transfer of an IPTV session between end user communication devices, such as between the set-top box 18 and the mobile video device 22. The session controller 48 also provides the appropriate control and decision-making to support access control, quality of service (QoS) and digital rights management (DRM) of IPTV content delivered to and transferred between various end user communication devices. The session controller 48 is coupled to the video storage element 46, the bearer controller 52 and the various access network interfaces 54. The session controller 48 also can be coupled directly to the IP network 26. The session controller 48 communicates with both the set-top box 18 and the mobile video device 22, via the appropriate access network or network control point.

The session controller 48 interfaces with the appropriate access network interface 54 and the bearer controller 52 to initiate, terminate and control the transfer of IPTV content to the mobile video device 22. For example, the session controller 48 interfaces with AAA (Authentication, Authorization, Accounting) servers within or coupled to the IP network 26 to obtain the appropriate authentication of end users and end user devices, as well as authorization of the end users to access various available IPTV content and associated services.

The session controller 48 also initiates access with the appropriate access network 32, 34 for the mobile video device 22 and negotiates QoS parameters with the access network. The session controller 48 is a QoS policy decision point for the control server 38. The session controller 48 receives access network flow information and, based on this information, interacts with the bearer controller 52 to provide or determine the most efficient data transfer involving the control server 38. The session controller 48 serves this function for both content received by the control server 38 (e.g., via the IDSI 42 and the IVI 44), as well as content transferred from the control server 38 (e.g., via the appropriate access network interface 54) by resolving video delivery requests against QoS policy for a subscriber or group of subscribers and/or access networks.

With respect to DRM, the session controller 48 enforces DRM for delivery of IPTV content to the appropriate end users and end user communication devices. The session controller 48 also provides interworking between different types of DRM, both on the end user communication device side and the network side.

The session controller 48 interfaces with the IDSI 42 to provide EPG information, e.g., to the mobile video device 22, as well as any interworking between different EPG formats. The session controller 48 also interfaces with the set-top box 18 to provide stored content to the mobile video device 22 or other suitable end user communication device. The interface with the set-top box 18 provided by the session controller 48 also allows mobile video device 22, via the control server 38, to communicate with and control various functions of the set-top box 18.

The session controller 48 controls the insertion of content in the video stream to the end user. The content insertion can be local to a group of users, or user specific and targeted at a specific user. The session controller 48 also supports and controls access by the end user to interactive features of IPTV. The session controller 48 also interfaces with the mobile video device 22 to perform channel selection. The session controller 48 also maintains the status and state for various mobile video devices associated with the control server 38 and the system 10.

The bearer controller 52 is responsible for the transfer and flow control of IPTV video content from the video storage element 46 to the mobile video device 22, via the appropriate access network interface 54. The session controller 48 supplies IPTV session control information to the bearer controller 52 on IPTV session content and flow. Such IPTV session control information includes information received from the appropriate wireless access network, such as hints, triggers, handoff information, congestion information and other control information. Such IPTV session control information also includes information received from the mobile video device 22 and other network elements.

The bearer controller 52 also handles real-time flow control with the mobile video device 22, including QoS enforcement and trick play instructions received by the end user from the mobile video device 22. The mobile video device 22 typically has some amount of buffering for video playback. The bearer controller 52 maintains the mobile device buffer as close to maximum as possible, even during drop outs and handovers. Such buffering is done to provide continuous IPTV video content to the mobile video device 22 for viewing.

The bearer controller 52 also is responsible for transcoding that may be required. Such transcoding can be done on an individual basis. The bearer controller 52 also is responsible for formatting the IPTV video content that is sent to the mobile video device 22. Such formatting can take the form of MPEG compression or direct screen information.

The access network interfaces 54 are responsible for interfacing the control server 38 with the appropriate wired or wireless access network or network control point being supported. The particular access network interface 54 typically will be different for various supported access networks to allow for appropriate interfacing with the various access networks and their respective capabilities. For example, the supported wireless networks can include WiMAX, HSxPA, and Ev-Do. The access network interface 54 interworks the protocols used by the particular access network with the protocols used in the control server 38 to support the functionality supported by the access network. In general, the access network interface 54 routes control information to the session controller 48 and bearer traffic to the bearer controller 52.

The access network interface 54 also supports any access network specific information, such as hints, triggers, handoff information, congestion information, QoS information and other suitable information. Such information is passed to the session controller 48. As discussed hereinabove, the session controller 48 uses such information to make decisions related to content flow and IPTV session control.

It should be understood that one or more of the IDSI 42 and the IVI 44 can be a single input/output interface. Also, it should be understood that one or more of the access network interfaces 54 can be an interface configured to support more than one connection from more than one access network or network control point.

The control server 38 also can include the management controller 56. The management controller 56 generally is responsible for the configuration, operation and management of the control server 38. The management controller 56 is coupled to the other components in the control server 38, e.g., using an appropriate formatting interface. The management controller 56 also collects and provides statistics on the individual components of the control server 38, as well as the overall operation of the control server 38.

One or more of the IPTV distribution system interface 42, the Internet video interface 44, the IPTV content storage element 46, the session controller 48, the bearer controller 52, the access network interfaces 54 and the management controller 56 can be comprised partially or completely of any suitable structure or arrangement, e.g., one or more integrated circuits. Also, it should be understood that the control server 38 includes other components, hardware and software (not shown) that are used for the operation of other features and functions of the control server 38 not specifically described herein.

The control server 38 can be partially or completely configured in the form of hardware circuitry and/or other hardware components within a larger device or group of components. Alternatively, the control server 38 can be partially or completely configured in the form of software, e.g., as processing instructions and/or one or more sets of logic or computer code. In such configuration, the logic or processing instructions typically are stored in a data storage device, e.g., the IPTV content storage element 46 or other suitable data storage device (not shown). The data storage device typically is coupled to a processor or controller, e.g., the session controller 48, the bearer controller 52 and/or the management controller 56. The controller accesses the necessary instructions from the data storage element and executes the instructions or transfers the instructions to the appropriate location within the control server 38.

In general, as discussed hereinabove, the control server 38 coordinates and facilitates the transfer of an IPTV session between end user communication devices, i.e., from an IPTV content source to a first end user communication device (e.g., a set-top box) to the IPTV content source to a second end user communication device (e.g., a particular mobile video device). The control server 38 is configured to receive and buffer or store at least a portion of the same IPTV content that is transmitted by the IPTV content source to the set-top box. The control server 38 also is configured to manage and control the distribution or transfer of the IPTV content received and/or stored thereby to a given mobile video device. Such management and control can be in response to IPTV session control information transmitted to the control server 38 by one or more of the set-top box and the particular mobile video device for which IPTV session mobility is to be provided. However, IPTV session control information can be transmitted from any suitable source or device to the control server 38. In this manner, an IPTV session from the IPTV content source can be transferred between a set-top box and a mobile communication device in a manner that allows an end user viewing the IPTV session on the transferring device to seamlessly continue viewing the same IPTV session on the device to which the IPTV was transferred. As will be discussed in greater detail hereinbelow, the control server 38 is configured to provide the IPTV content to the mobile communication device in the same (or different) form as is being transmitted to the set-top box, e.g., the same viewing point or location as is being shown by the set-top box. Alternatively, the control server 38 can store all or a portion of the IPTV content and provide it to the mobile video device in some other manner.

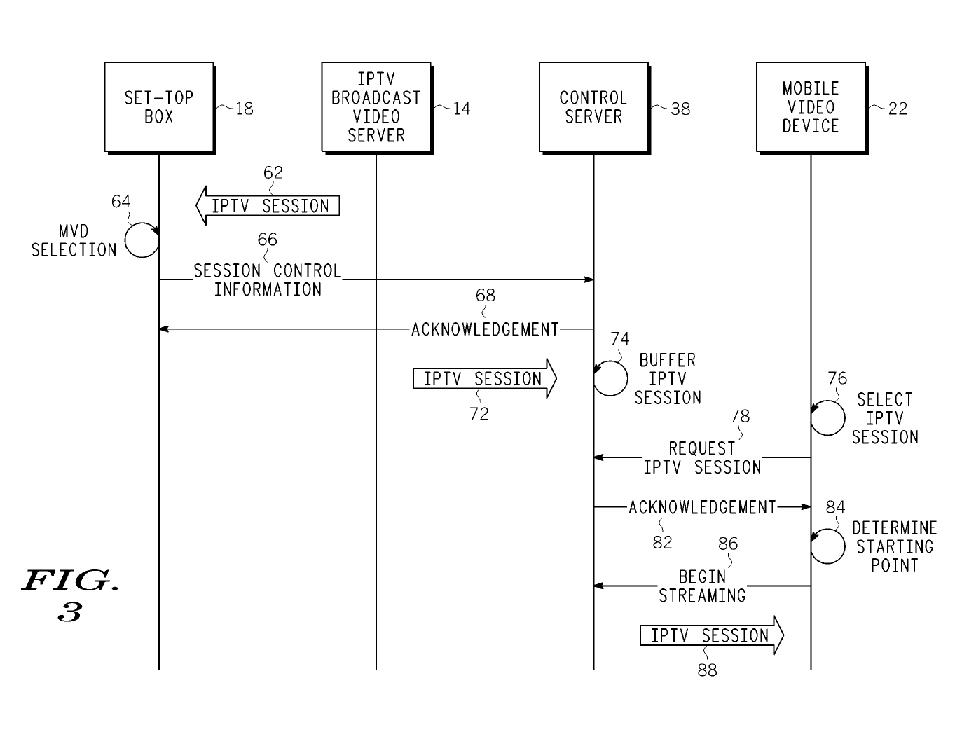

Referring now to FIG. 3, shown is a flow diagram of an IPTV session transfer from a first end user communication device, e.g., the set-top box 18, to a second end user communication device, e.g., the mobile video device 22. For example, an end user watching a particular IPTV video stream “channel” on the set-top box 18 would like to be able to watch the same IPTV session on the mobile video device 22. In this example, the IPTV session transfer is initiated by the end user from the set-top box, although such is not necessary, as the transfer can be initiated by some other appropriate device or means. The end user can initiate the transfer from the set-top box in any suitable manner, e.g., using a remote control unit for the set-top box, which typically is an infrared or radio frequency (RF) control unit having a suitable user interface. As will be discussed in greater detail hereinbelow, upon transfer, the IPTV session can be viewed on the mobile video device 22 at the point at which the IPTV session was transferred from the set-top box, the current point or location in the IPTV session, or anywhere in between. The control server 38 facilitates the transfer, including the selected viewing position within the video content.

In this example, it is assumed that the set-top box 18 is connected to the IPTV broadcast video server 14 (or other appropriate IPTV content source) via the wireline access network 28 (e.g., a broadband wireline access network) to an IP network to which the IPTV session is delivered (e.g., the IP network 26), and that the IPTV session is being delivered to the set-top box 18. Also, the mobile video device 22 is connected to the IP network 26 via the appropriate wireless access network (e.g., the wireless access network 32 or the wireless broadcast network 34). As will be shown in the flow diagram, the IPTV session is delivered to the mobile video device 22 via the control server 38. It is assumed that the mobile video device 22 has registered itself to the system 10 and is a known member of a transferable device group. It should be understood that the service provider for the set-top box 18 via the wireline access network 28 may or may not also be the service provider for the mobile video device 22 via the mobile access network (e.g., access network 32 and/or access network 34). If the service providers are different, it is assumed that a service agreement or other appropriate agreement has been reached between the different service providers.

The flow diagram generally shows the various flow of IPTV content (as part of an IPTV session) and the flow of IPTV session control information between the set-top box 18, the IPTV content source (e.g., the IPTV broadcast video server 14), the control server 38 and the mobile video device 22. Initially, it is assumed that there is an IPTV session, shown generally as an IPTV session 62. That is, the IPTV content source 14 is transmitting IPTV content to the set-top box 18.

The end user is viewing the IPTV session 62 on a display device connected to the set-top box 18. In this example, the end user is leaving the vicinity of the set-top box 18 and would like to transfer the IPTV session to the end user's mobile video device 22. Moreover, the end user also would like to begin viewing the IPTV session on the mobile video device 22 at the point in the session that was being shown on the set-top box 18 at the time the end user left the vicinity of the set-top box 18. That is, the end user would like to resume viewing the IPTV session at the point or location in the session from which the end user will leave off with prior to the moment of session transfer.

The end user selects the appropriate mobile video device to which to transfer the IPTV session, e.g., the mobile video device 22, and initiates a transfer function. The selection and transfer initiation can be made in any suitable manner using any suitable device or devices, e.g., using the remote control unit of the set-top box 18. The selection and transfer initiation are shown generally as a selection 64 in the flow diagram.

In response to the transfer initiation, the set-top box 18 communicates to the control server 38 to identify the IPTV session, the current timecode (i.e., viewing point or location in the IPTV session), and the mobile video device 22 that will be retrieving the IPTV session. Such information, which can be in the form of metadata, is considered to be at least part of a first set of IPTV session control information that is communicated to the control server 38. This particular communication from the set-top box 18 to the control server 38 is shown generally as a communication 66. In response, the control server 38 can communicate an acknowledgement 68 to the set-top box 18.

The control server 38 begins buffering the IPTV session for the mobile video device 22. Such IPTV session is shown generally as an IPTV session 72 from the IPTV content source 14 to the control server 38. The control server 38 buffering the IPTV session is shown generally as a buffering 74.

Once the mobile video device 22 is registered with the control server 38 (assuming the mobile video device 22 has not already been registered with the control server 38), the mobile video device 22 is ready for the end user to initiate the retrieval of the (transferred) IPTV session. At this point, the end user can select an option 76 of retrieving the IPTV session. In response, the mobile video device 22 requests the IPTV session from the control server 38. Such request is shown generally as a request 78. In response, the control server 38 can communicate an acknowledgement 82 to the mobile video device 22. The acknowledgement 82 can include information (e.g., metadata) regarding the identification of the selected IPTV session, confirmation of the registration of the mobile video device 22 and other appropriate IPTV session control information. Such information is considered to be at least part of a second set of IPTV session control information that is communicated to the control server 38.

The end user typically will have the option of starting, i.e., resuming, the IPTV session at any appropriate point or location in the IPTV session, e.g., the point at which the IPTV session was transferred from the set-top box 18, the current point in the IPTV session or anywhere in between. The end user determines the desired starting point of the transferred IPTV session (shown generally as a determination 84). Once the end user has selected the desired starting point in the transferred IPTV session, the mobile video device 22 communicates a request 86 to the control server 38 to begin streaming the IPTV session to the mobile video device 22. The request 86 typically includes the end user's desired starting point for the transferred IPTV session. The information in the request 86 also is considered to be at least part of a second set of IPTV session control information that is communicated to the control server 38.

In response to the request 86, the control server 38 begins streaming the IPTV session to the mobile video device 22. The IPTV session is shown generally as a transferred IPTV session 88 in the data flow diagram. In this manner, the IPTV session, which was being viewed by the end user on a display device connected to the set-top box 18, now is being viewed without interruption by the end user on the mobile video device 22.

It should be understood that the transfer of an IPTV session does not require signaling to the particular IPTV content source, e.g., the IPTV broadcast video server 14. The control server 38 (or other element) that determines which IPTV sessions are sent from which end user communication device to which end user communication device receives all involved multicast streams from the IPTV source.

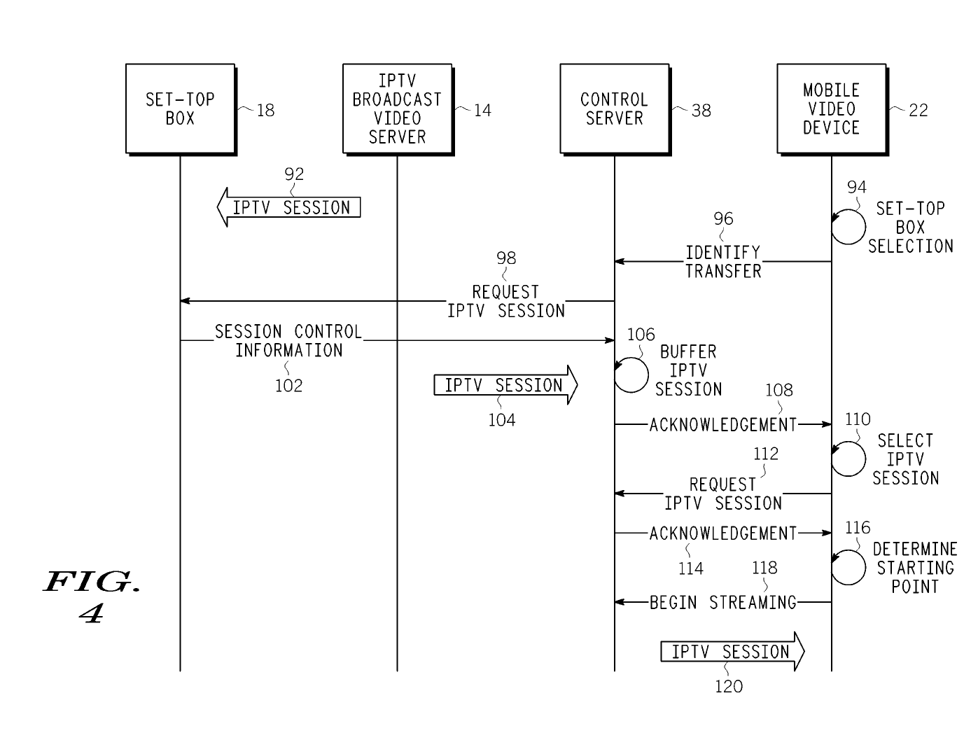

Referring now to FIG. 4, shown is a flow diagram of an IPTV session transfer from the set-top box 18 to the mobile video device 22. The session transfer is similar to the session transfer shown in FIG. 3 and just discussed, however, in this example, the session transfer is initiated from the mobile video device 22 (rather than from the set-top box 18). The end user can initiate the transfer from the mobile video device 22 in any suitable manner, e.g., using the device keypad or other end user interface.

As with the previous example scenario, upon transfer, the IPTV session can be viewed on the mobile video device 22 at the point at which the IPTV session was transferred from the set-top box, the current point or location in the IPTV session, or anywhere in between. Also, the control server 38 facilitates the transfer.

In this example scenario, the assumptions are similar to the previously-described scenario. For example, it is assumed that the set-top box 18 is connected to the IPTV broadcast video server 14 (or other appropriate IPTV content source) via the wireline access network 28 to an IP network to which the IPTV session is delivered (e.g., the IP network 26), and that the IPTV session is being viewed on an appropriate display device connected the set-top box 18. Also, the mobile video device 22 is connected to the IP network 26 via the appropriate wireless access network. Also, it is assumed that the mobile video device 22 has registered itself to the system 10 and is a known member of a transferable device group, and that the service provider for the set-top box 18 and the mobile video device 22 is the same service provider, or a service agreement or other appropriate agreement has been reached between the service providers if they are different.

The flow diagram generally shows the various flow of IPTV content as part of the IPTV session and the flow of IPTV session control information between the set-top box 18, the IPTV content source (e.g., the IPTV broadcast video server 14), the control server 38 and the mobile video device 22. Initially, it is assumed that there is an IPTV session, which is shown generally as an IPTV session 92. That is, the IPTV content source 14 is transmitting IPTV content to the set-top box 18.

The end user is viewing the IPTV session 92 on a display device connected to the set-top box 18. In this example, the end user is leaving the vicinity of the set-top box 18 and would like to transfer the IPTV session to the end user's mobile video device 22. Moreover, the end user also would like to begin viewing the IPTV session on the mobile video device 22 at the point in the session that was being shown on the set-top box display device at the time the end user left the vicinity of the set-top box 18. That is, the end user would like to resume viewing the IPTV session at the point or location in the session from which the end user will leave off with prior to the moment of session transfer.

Using the mobile video device 22, the end user selects the appropriate device from which to transfer the IPTV session, e.g., the set-top box 18, from a list of possible end user communication devices associated with and made available to the mobile video device 22. The end user initiates a transfer function using the mobile video device 22. The selection and transfer initiation are shown generally as a selection 94 in the flow diagram.

In response to the transfer initiation by the mobile video device 22, the mobile video device 22 communicates to the control server 38 to identify the source from which the IPTV session should be transferred, e.g., the set-top box 18, in this example. Such communication is shown generally as a request 96 in the flow diagram. The control server 38 requests the IPTV session from the set-top box 18. Such request is shown generally as a request 98.

In response to the request 98, the set-top box 18 acknowledges the request and communicates to the control server 38 with the IPTV session identification (ID) and the current session timecode. Such information, which can be in the form of metadata, is considered to be at least part of a first set of IPTV session control information that is communicated to the control server 38. This particular communication from the set-top box 18 to the control server 38 is shown generally as a session control information communication 102.

The control server 38 begins buffering the IPTV session for the mobile video device 22. Such IPTV session is shown generally as an IPTV session 104 from the IPTV content source 14 to the control server 38. The control server 38 buffering the IPTV session is shown generally as a buffering 106.

The control server 38 acknowledges the IPTV session transfer request 96 from the mobile video device 22 with the IPTV session identification (ID) and the current session timecode (to the mobile video device 22). Such acknowledgement is shown generally as an acknowledgement 108. The end user then selects, via the mobile video device 22, the option to retrieve the IPTV session. Such retrieval/selection is shown generally as a selection 110. In response to the end user selection 110, the mobile video device 22 requests the IPTV session from the control server 38. The request is shown generally as a request 112. In response to the request 112, the control server 38 acknowledges the request (acknowledgement 114). The acknowledgement 114 can include information (e.g., metadata) regarding the identification of the selected IPTV session, confirmation of the registration of the mobile video device 22 and other appropriate IPTV session control information.

The end user typically has the option of starting, i.e., resuming, the IPTV session at any appropriate point or location in the IPTV session, e.g., the point at which the IPTV session was transferred from the set-top box 18, the current point in the IPTV session or anywhere in between. The end user determines the desired starting point of the transferred IPTV session (shown generally as a determination 116). Once the end user has selected the desired starting point in the transferred IPTV session, the mobile video device 22 communicates a request 118 to the control server 38 to begin streaming the IPTV session to the mobile video device 22. The request 118 typically includes the end user's desired starting point for the transferred IPTV session. The information in the request 118 is considered to include at least part of a second set of IPTV session control information that is communicated to the control server 38.

In response to the request 118, the control server 38 begins streaming the IPTV session to the mobile video device 22. The IPTV session is shown generally as a transferred IPTV session 120. In this manner, the IPTV session, which was being viewed by the end user on the set-top box 18, now is being viewed without interruption by the end user on the mobile video device 22.

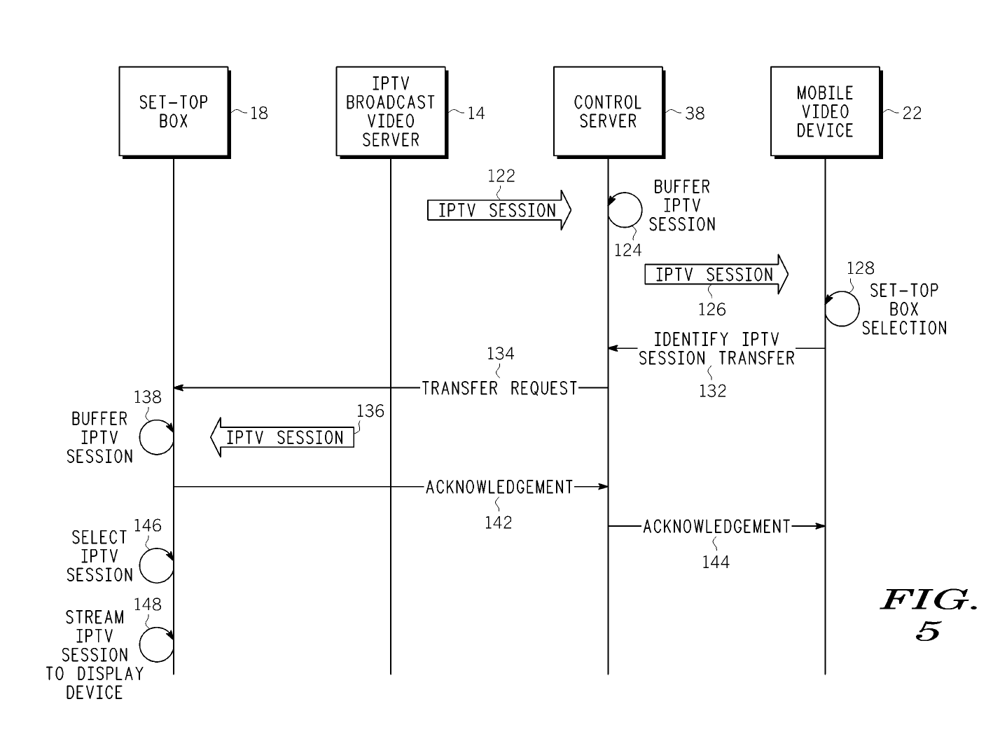

Referring now to FIG. 5, shown is a flow diagram of an IPTV session transfer from the mobile video device 22 to the set-top box 18. For example, an end user viewing a particular IPTV video stream “channel” on the mobile video device 22 arrives at the home or other vicinity of the set-top box 18 and would like to transfer the IPTV session to the set-top box 18. Therefore, in this example, the IPTV session will be transferred from the mobile video device 22 to the set-top box 18 without interruption. The transfer is initiated by the end user using the mobile video device 22 or the set-top box 18, although such is not necessary. For example, the end user can initiate the transfer by some other appropriate device or means. The control server 38 facilitates the transfer, including the selected viewing position within the video content.

In this example scenario, the assumptions are similar to the previously-described scenarios. For example, it is assumed that the set-top box 18 is connected to the IPTV broadcast video server 14 (or other appropriate IPTV content source) via the wireline access network 28 to an IP network to which the IPTV session is delivered (e.g., the IP network 26). Also, it is assumed that the mobile video device 22 is connected to the IP network 26 via the appropriate wireless access network, and that the IPTV session is being viewed on the mobile video device 22. Also, it is assumed that the mobile video device 22 has registered itself to the system 10 and is a known member of a transferable device group (i.e., the mobile video device 22 is associated with the set-top box 18). The service provider for the set-top box 18 via the wireline access network 28 and the mobile video device 22 via the mobile access network 32, 34 is the same service provider, or a service agreement or other appropriate agreement has been reached between the service providers if they are different.

The flow diagram generally shows the various flow of IPTV content as part of an IPTV session and the flow of IPTV session control information between the set-top box 18, the IPTV content source (e.g., the IPTV broadcast video server 14), the control server 38 and the mobile video device 22. Initially, it is assumed that there is an existing IPTV session. That is, the IPTV content source 14 is transmitting IPTV content to the control server 38 (shown generally as an IPTV session 122). The control server 38 is buffering all or a portion of the received IPTV content (shown generally as a buffering 124), and transmitting the received IPTV content to the mobile video device 22, which is shown generally as IPTV session 126.

Using the mobile video device 22, the end user selects the appropriate device to which to transfer the IPTV session, e.g., the set-top box 18, from a list of possible end user communication devices associated with and made available to the mobile video device 22. The end user initiates a transfer function using the mobile video device 22. The selection and transfer initiation are shown generally as a selection 128 in the flow diagram. As discussed hereinabove, it should be understood that such selection and transfer initiation can be made by other appropriate means, e.g., using the set-top box 18.

In response to the transfer initiation by the mobile video device 22, the mobile video device 22 communicates to the control server 38 to identify the IPTV session, the current timecode (i.e., viewing point or location in the IPTV session), and the set-top box 18 that will be retrieving the IPTV session. This particular communication from the mobile video device 22 to the control server 38 is shown generally as a communication 132 in the flow diagram.

Based on the receipt of this IPTV session control information, the control server 38 requests the transfer of the IPTV session to the set-top box 18. The transfer request is shown generally in the flow diagram as a request 134 from the control server 38 to the set-top box 18.

In response to the request 134, the set-top box 18 begins buffering the IPTV session from the IPTV content source 14. Such IPTV session is shown generally as an IPTV session 136. The set-top box 18 buffering the IPTV session is shown generally as a buffering 138 in the flow diagram.

In response to the transfer request 134 from the control server 38, the set-top box 18 communicates to the control server 38 an acknowledgement 142 of the IPTV session transfer request. The control server 38 then communicates to the mobile video device 22 an acknowledgement 144 of the IPTV session transfer. Each of the acknowledgement 142 and the acknowledgement 144 can include information (e.g., metadata) regarding the identification of the selected IPTV session, the current viewing point or location in the IPTV session, set-top box identification information, and other appropriate IPTV session control information.

At this point, the set-top box 18 is ready for the end user to initiate the retrieval of the IPTV session. The end user typically has the option of starting, i.e., resuming, the IPTV session at any appropriate point or location in the IPTV session, e.g., the point at which the IPTV session was transferred from the mobile video device 22, the current point in the IPTV session or anywhere in between. The end user determines the desired starting point of the transferred IPTV session (shown generally as a selection 146). Once the end user has selected the desired starting point in the transferred IPTV session, the set-top box 18 begins the transfer of the IPTV session to its associated display device (not shown), such as a television, computer monitor or other appropriate display device coupled to or incorporated in the set-top box 18. The transfer is shown generally in the flow diagram as an IPTV session stream 148. The IPTV session, which was being viewed on the mobile video device 22, now is being viewed without interruption by the set-top box 18 (via its connected display device).

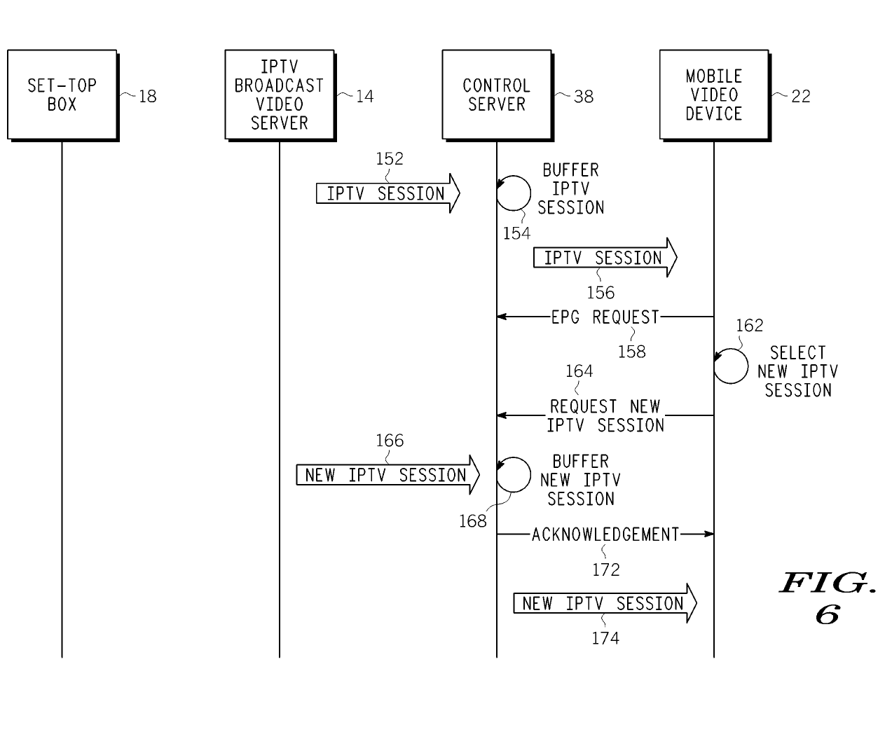

Referring now to FIG. 6, shown is a flow diagram of an IPTV session change (i.e., a “channel” change) for a mobile end user communication device, such as the mobile video device 22. The flow diagram illustrates how an IPTV session change is selected on the mobile video device 22.

Initially, it is assumed that the end user is viewing an active IPTV session on the end user's mobile video device 22. That is, the IPTV content source 14 is transmitting IPTV content to the control server 38, which is buffering all or a portion of the received video content, and transmitting the received IPTV content to the mobile video device 22. In the flow diagram, the transmission of the IPTV session from the IPTV content source 14 to the control server 38 is shown generally as an IPTV session 152. The control server 38 buffering the video content is shown generally as a buffering 154. The transmission of the video session from the control server 38 to the mobile video device 22 is shown generally as a video session 156.

Using the mobile video device 22, the end user requests and obtains an electronic program guide (EPG) from the control server 38. Such request is shown generally as a request 158 in the flow diagram. The electronic program guide can be transmitted along with or separately from the IPTV content transmitted from the IPTV content source 14. Also, the electronic program guide can be stored in the control server 38, e.g., as part of the buffering 154 performed by the control server 38.

Once the mobile video device 22 obtains the electronic program guide, the end user, e.g., via the mobile video device 22, selects the new IPTV session (channel), from the electronic program guide, that the end user would like to view. This selection is shown generally as a selection 162 in the flow diagram.

In response to the end user's selection 162, the mobile video device 22 communicates to the control server 38 a new IPTV session request 164, which identifies the new IPTV session desired by the end user. In response to the request 164, the control server 38 begins receiving and buffering the new IPTV session. The new IPTV session is shown generally as an IPTV session 166 and the buffering of the new IPTV session is shown generally as a buffering 168.

In response to the IPTV session change request 164 from the mobile video device 22, the control server 38 communicates to the mobile video device 22 an acknowledgement 172 of the IPTV session change request. Also, the control server 38 begins streaming the new IPTV session to the mobile video device 22. The new IPTV session (from the control server 38 to the mobile video device 22) is shown generally as a new IPTV session 174. In this manner, the end user now is viewing a new/different IPTV session displayed on the mobile video device 22.

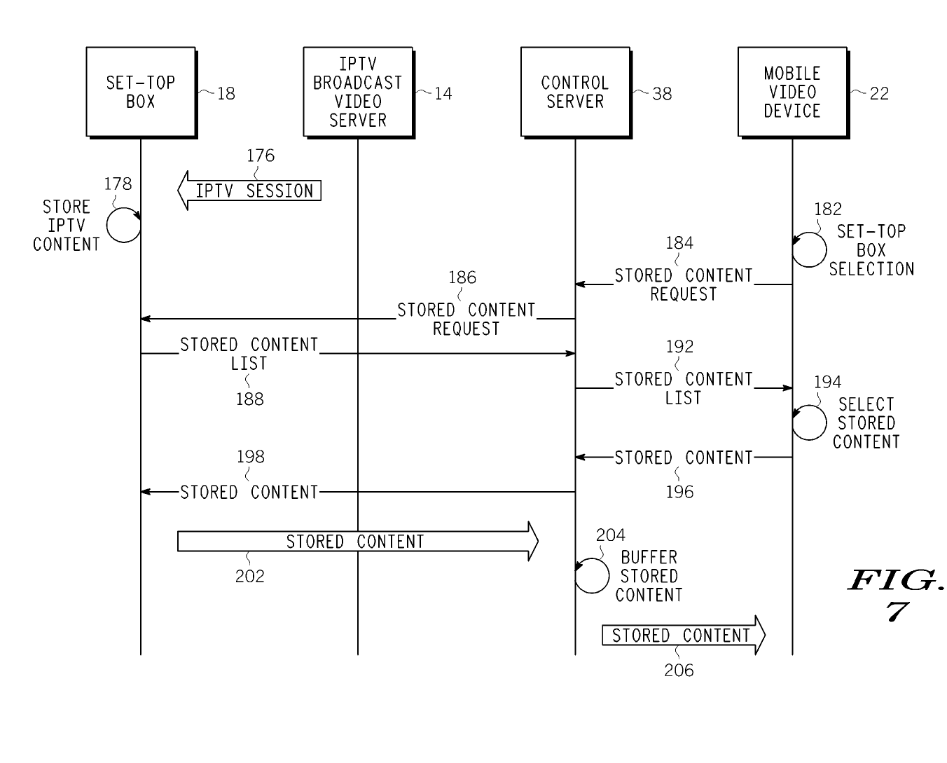

Referring now to FIG. 7, shown is a flow diagram of the retrieval of IPTV content stored on an end user communication device, such as the set-top box 18, by the mobile video device 22. For example, the set-top box 18 has stored IPTV content from an earlier IPTV session. The end user wants to retrieve the stored IPTV content from the set-top box 18 and view the retrieved IPTV content on the mobile video device 22. The IPTV content retrieval is to be initiated by the end user from the mobile video device 22, although such is not necessary, as the transfer can be initiated by some other appropriate device or means, such as from set-top box 18, e.g., using its remote control unit. The control server 38 facilitates the retrieval, including the selected viewing position within the retrieved IPTV content.

In this example scenario, many of the assumptions are similar to those in the previously-described scenarios. For example, it is assumed that the set-top box 18 is connected to the IPTV broadcast video server 14 (or other appropriate IPTV content source) via the wireline access network 28 to an IP network to which the IPTV session is delivered (e.g., the IP network 26). Also, it is assumed that the mobile video device 22 is connected to the IP network 26 via the appropriate wireless access network, e.g., network 32 or network 34. Also, it is assumed that the mobile video device 22 has registered itself to the system 10 and is a known member of a transferable device group (i.e., the mobile video device 22 is associated with the set-top box 18). Also, the service provider for the set-top box 18 and the mobile video device 22 is the same service provider, or a service agreement or other appropriate agreement has been reached between the service providers if they are different.

The flow diagram generally shows the various flow of IPTV content and IPTV session control information between the set-top box 18, the IPTV content source (e.g., the IPTV broadcast video server 14), the control server 38 and the mobile video device 22. Initially, it is assumed that there was an IPTV session between the IPTV source 14 and the set-top box 18 (shown generally as an IPTV session 176), and the end user selected that the IPTV session 176 be stored on the set-top box 18 (shown generally as IPTV content storage 178).

Using the mobile video device 22, the end user selects the set-top box 18 from a list of possible end user communication devices associated with and made available to the mobile video device 22. Such selection is shown generally as a selection 182. The end user requests (to the control server 38) a list of the IPTV content stored on the set-top box 18. Such request is shown generally as a request 184. The control server 38 requests from the set-top box 18 a list of the IPTV content stored on the set-top box 18. Such request is shown generally as a request 186.

In response to the request 186 by the control server 38, the set-top box 18 provides the control server 38 with a list of IPTV content stored on the set-top box 18. Such response is shown generally as a stored content list response 188. The control server 38, in turn, transmits the list of stored IPTV content to the mobile video device 22. Such transmission is shown generally as a stored content list transmission 192.

Using the mobile video device 22, the end user selects from among the provided list the stored IPTV content to be viewed on the mobile video device 22 (shown generally as a selection 194) and then transmits to the control server 38 a request for the selected stored IPTV content to be viewed (shown generally as a stored content request 196). The control server 38 then requests the selected stored IPTV content from the set-top box 18 (shown generally as a stored content request 198).

In response to the request 198 from the control server 38, the set-top box 18 begins transferring the requested stored IPTV content to the control server 38. Such transfer is shown generally as a stored IPTV content transfer 202. The control server 38 buffers the stored content received from the set-top box 18. Such buffering is shown generally as a stored content buffering 204.

The control server 38 also begins streaming the buffered IPTV content to the mobile video device 22. Such is shown as an IPTV content stream 206 from the control server 38 to the mobile video device 22. In this manner, the end user can view on the mobile video device 22 IPTV content that previously was stored on the set-top box 18.

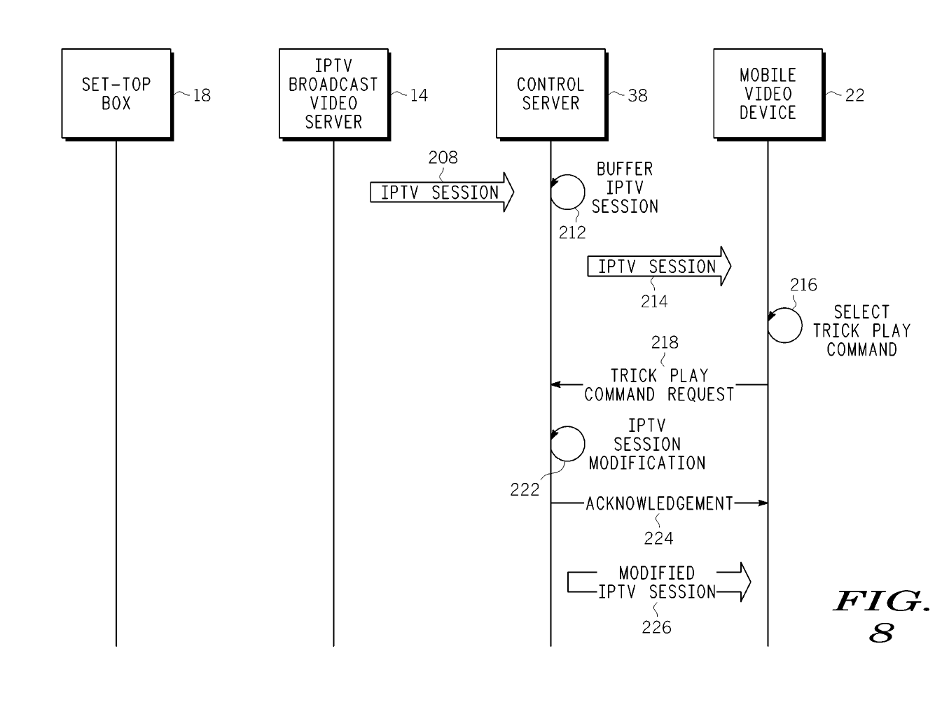

Referring now to FIG. 8, shown is a flow diagram of the use of trick play on IPTV content delivered to a mobile communication device, such as the mobile video device 22. As discussed hereinabove, trick play operations that can be performed on IPTV content streamed to an end user communication device, such as the mobile video device 22, can include pause, fast forward, fast rewind, slow forward, slow rewind, jump to previous/future frame and other possible operations. As will be seen, in this example scenario, the control server 38 acts much like a network Digital Video Recorder (DVR).

For example, an IPTV content stream currently being viewed by an end user on the mobile video device 22 is an active IPTV session from the control server 38 to the mobile video device 22. The end user then selects one of the trick play commands to be executed on the current IPTV content stream displayed to the mobile video device 22. The control server 38 facilitates the trick play command. In this example scenario, it is assumed that the mobile video device 22 is connected to the IP network 26 via the appropriate wireless access network, and that the IPTV session is being delivered from the IPTV content source 14 to the mobile video device 22 via the control server 38.

The flow diagram generally shows the various flow of IPTV content as part of an IPTV session and the flow of IPTV session control information between the IPTV content source (e.g., the IPTV broadcast video server 14), the control server 38 and the mobile video device 22. Initially, it is assumed that there is an IPTV session. That is, the IPTV content source 14 is transmitting IPTV content (shown generally as an IPTV session 208) to the control server 38. The control server 38 is buffering all or a portion of the received IPTV content (shown generally as a buffering 212), and transmitting the IPTV content (shown generally as IPTV session 214) to the mobile video device 22.

Using the mobile video device 22, the end user selects a trick play operation to be performed on the IPTV session. The selection can be made in any suitable manner using any suitable device or devices, e.g., using an appropriate end user interface on the mobile video device 22. In the flow diagram, the selection is shown generally as a trick play selection 216.

In response to the trick play selection 216, the mobile video device 22 sends an appropriate trick play command request to the control server 38. Such is shown generally as a trick play command request 218. Upon receipt of the trick play command request 218, the control server 38 modifies the IPTV session stream accordingly, i.e., based on the requested trick play command. Such modification is shown generally as an IPTV session modification 222. The control server 38 also can send an acknowledgement (shown generally as an acknowledgement 224) to the mobile video device 22.

Thus, based on the trick play command request 218 from the mobile video device 22, the control server 38 begins streaming the modified IPTV session to the mobile video device 22. The modified IPTV session is shown generally as a modified IPTV session 226. In this manner, the IPTV session being viewed on the mobile video device 22 is modified by the trick play command requested by the end user.

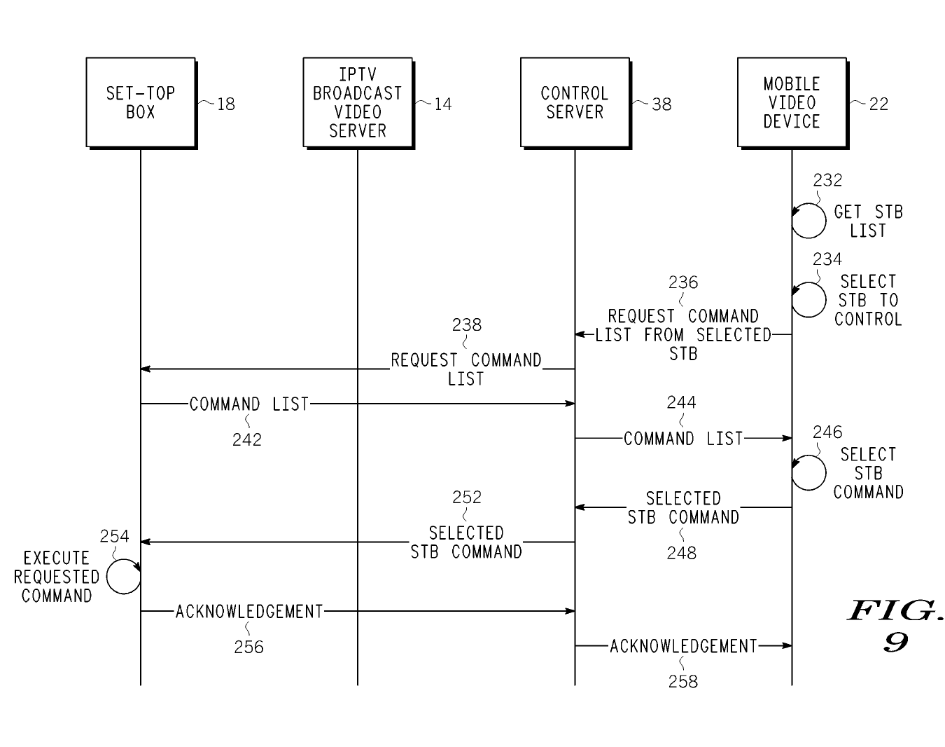

Referring now to FIG. 9, shown is a flow diagram of the control of the functionality of an end user communication device, such as the set-top box 18, by a mobile communication device, such as the mobile video device 22. For example, an end user can use the mobile video device 22 (or other suitable end user communication device) to control the functions of the set-top box 18 (or other suitable end user communication device). Such functions include viewing a list of stored IPTV content on the set-top box 18 (described hereinabove), configuring the set-top box 18 to record IPTV content, removing an item from the list of IPTV content items to be recorded and other suitable functions that the set-top box 18 is configured to perform. The control server 38 facilitates the functionality control process. Also, it is assumed that the mobile video device 22 is connected to the IP network 26 via the appropriate wireless access network, and that the mobile video device 22 has a list or access to a list of set-top boxes (or other end user communication devices) that can be controlled by the mobile video device 22.

The flow diagram generally shows the various flow of IPTV content as part of an IPTV session and IPTV session control information between the IPTV content source (e.g., the IPTV broadcast video server 14), the control server 38 and the mobile video device 22. Initially, using the mobile video device 22, the end user requests a list of possible end user communication devices associated with and made available to the mobile video device 22 that can be controlled, e.g., a list of set-top boxes that can be controlled. Such list can be obtained from the control server 38 or from the IPTV content source 14 via the control server 38. Such request is shown generally as a request 232. Upon receiving the list of available end user communication devices, the end user selects the set-top box 18 to be controlled. Such selection is shown generally as a selection 234 by the mobile video device 22.

Once the end user has selected the set-top box 18 to control, the end user, via the mobile video device 22, requests to the control server 38 a list of commands for the selected set-top box 18. The request is shown generally as 236. The control server 38, in turn, requests the command list from the selected set-top box 18. Such request is shown generally as a request 238 from the control server 38 to the set-top box 18.

In response to the command list request 238, the set-top box 18 sends the requested command list to the control server 38. Such transfer is shown generally as a command list transfer 242. The control server 38, in turn, sends the requested command list to the mobile video device 22. Such transfer is shown generally as a command list transfer 244.

Once the mobile video device 22 has received the requested command list for the selected set-top box 18, the end user can select (via the mobile video device 22) the desired set-top box command to have executed by the set-top box 18. Such set-top box command selection is shown generally as a command selection 246. The mobile video device 22 then sends the selected command to the control server 38. Such selected command transfer is shown generally as 248. The control server 38, in turn, sends the selected command to the selected set-top box 18. Such transfer is shown generally as 252.

Once the set-top box 18 has received the selected command, the set-top box 18 executes the selected command. For example, if the selected command is to record a particular IPTV session, the set-top box 18 begins recording the particular IPTV session when the IPTV session is made available to the set-top box 18, e.g., from the IPTV source 14. Such execution is shown generally as an execution 254. The set-top box 18 sends an acknowledgement to the control server 38 when the command execution has been initiated and/or when the command execution has been completed. Such acknowledgement is shown generally as an acknowledgement 256. The control server 38 sends the acknowledgement to the mobile video device 22. Such acknowledgement is shown generally as an acknowledgement 258. In this manner, using the mobile video device 22, the end user has performed or executed a set-top box function on the set-top box 18.

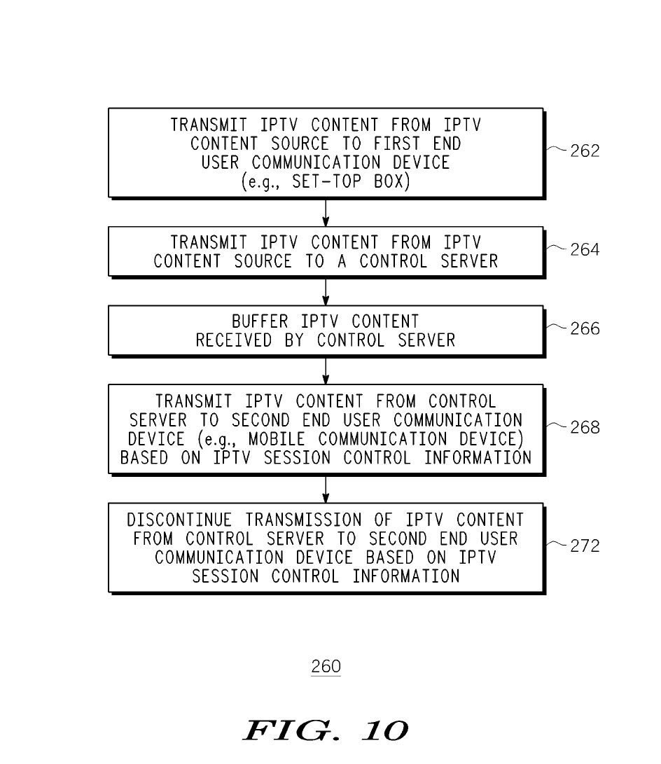

Referring now to FIG. 10, shown is a block diagram of a method 260 for providing IPTV session mobility between end user communication devices, such as between the set-top box 18 and the mobile video device 22. The method 260 includes a step 262 of transmitting IPTV content from at least one of the IPTV content sources 12, 14, 16 to the set-top box 18. As discussed hereinabove, the IPTV content sources can transmit IPTV content to the set-top box 18 in any suitable manner, e.g., via the IP network 26 and the wireline access network 28.

The method 260 also includes a step 264 of transmitting IPTV content from at least one of the IPTV content sources 12, 14, 16 to the control server 38. The IPTV content source can transmit the IPTV content to the control server 38, e.g., via the IP network 26.

The method 260 also includes a step 266 of the control server 38 buffering or storing at least a portion of the IPTV content received from the IPTV source. As discussed hereinabove, the control server 38 includes one or more suitable storage elements, such as the storage element 46, suitable to buffer all or a portion of the IPTV content transmitted to the control server 38. The storage of the received IPTV content can be performed in anticipation of the transmission of IPTV content from the control server 38 to the mobile video device 22, e.g., as part of an IPTV session transfer.

The method 260 also includes a step 268 of transmitting IPTV content from the control server 38 to the mobile video device 22, based on IPTV session control information received by the control server 38. As discussed hereinabove, the control server 38 can receive IPTV session control information, e.g., from the set-top box 18, that identifies the mobile video device 22 and the transfer of a particular IPTV video session to the mobile video device 22. The IPTV session control information, which can be in the form of metadata, also can include various additional information regarding the transfer of an IPTV video session to the mobile video device 22, such as the current timecode or viewing location in the IPTV video session by the communication device (e.g., set-top box 18) from which the IPTV session transfer is to occur. The transmission step 268 is part of the control server 38 managing and facilitating the transfer of an IPTV video session, e.g., from the set-top box 18 to the mobile video device 22.

The method 260 also includes a step 272 of discontinuing or terminating the transmission of IPTV content from the control server 38 to the mobile video device 22, based on IPTV session control information received by the control server control server 38. For example, IPTV session control information can be transmitted from the mobile video device 22 to the control server 38 indicating that the transferred IPTV session is to be discontinued or terminated. For example, when an end user wishes to discontinue viewing an IPTV video session that previously had been transferred to the end user's mobile video device 22, the end user can transmit appropriate IPTV session control information to the control server 38 that will cause the control server 38 to discontinue transmitting IPTV content to the mobile video device 22.

Like the transmission step 268, the step 272 of discontinuing the transmission of IPTV content is part of the control server 38 managing and facilitating the transfer of an IPTV session between the set-top box 18 and the mobile video device 22.

It should be understood that, as discussed in example scenarios hereinabove, the IPTV session mobility method 260 includes transferring an IPTV session from the mobile video device 22 to the set-top box 18. In such case, the transmission step 262 to the set-top box 18 would occur after the transmission step 268 to the mobile video device 22. That is, IPTV content would be transmitted from an IPTV content source to the control server 38 (step 264), IPTV content would be buffered by the control server 38 (step 266), and the control server 38 would transmit IPTV content to the mobile video device 22. In response to appropriate IPTV session control information, the control server 38 would facilitate the transfer of the IPTV session from the mobile video device 22 to the set-top box 18. See, e.g., FIG. 5 and the corresponding discussion hereinabove.

Also, as discussed hereinabove, providing IPTV session mobility between the set-top box 18 and the mobile video device can include changing the “channel” of an IPTV session involving the set-top box 18 or the mobile communication device 22. Also, as discussed hereinabove, providing IPTV session mobility can include performing trick play operations on IPTV content transmitted as part of an IPTV session. Also, as discussed hereinabove, providing IPTV session mobility can include controlling at least a portion of the operations of an end user communication device, such as the set-top box 18, using a different end user communication device, such as the mobile video device 22.

The IPTV session mobility methods, devices and systems described hereinabove can be partially or completely packaged, stored, built or otherwise contained on or within one or more end user communication devices. Alternatively, the IPTV session mobility methods and systems described hereinabove can be partially or completely packaged, stored, built or otherwise contained on or within one or more network device or device components, or standalone devices or components, to which one or more of the end user communication devices is or can be coupled.

The method shown in FIG. 10 may be implemented in a general, multi-purpose or single purpose processor. Such a processor will execute instructions, either at the assembly, compiled or machine-level, to perform that process. Those instructions can be written by one of ordinary skill in the art following the description of FIG. 10 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the IPTV session mobility methods, devices and systems herein described without departing from the spirit and scope of the invention as defined by the appended claims and their full scope of equivalents.

1. A method for providing session mobility between a first end user communication device and a second end user communication device, wherein the first end user communication device and the second end user communication device are coupled to an Internet Protocol (IP) network, and wherein the first end user communication device is configured to receive Internet Protocol Television (IPTV) content from at least one IPTV content source coupled to the IP network to establish a first IPTV session, comprising the steps of:
communicating a first set of IPTV session control information between a control server coupled to the IP network and the first end user communication device, wherein the first end user communication device is configured to receive IPTV content from the IPTV content source in response to the communication of at least a portion of the first set of IPTV session control information;
communicating a second set of IPTV session control information between the control server and the second end user communication device;
receiving by the control server from the IPTV content source, in response to the communication of IPTV session control information between the control server and at least one of the first and second end user communication devices, at least a portion of the IPTV content transmitted to the first end user communication device from the IPTV content source; and
transmitting by the control server at least a portion of the IPTV content received thereby to the second end user communication device in response to the communication of IPTV session control information between the control server and at least one of the first and second end user communication devices, wherein the transmission of IPTV content to the second end user communication device establishes a second IPTV session in a manner that provides IPTV session mobility between the first and second end user communication devices.

2. The method as recited in claim 1, wherein the IPTV session control information includes the selection of an end user communication device to which an IPTV session is to be established.

3. The method as recited in claim 1, wherein the IPTV session control information includes at least one of an identification of an IPTV session being transmitted to an end user communication device, a current viewing position in the identified IPTV session, and an identification of an end user communication device to be provided with IPTV content to establish an IPTV session.

4. The method as recited in claim 1, wherein the receiving step includes receiving IPTV content stored in the first end user communication device.

5. The method as recited in claim 1, wherein the IPTV session control information includes trick play information communicated between the control server and the first and second end user communication devices.

6. The method as recited in claim 1, wherein the IPTV session control information includes operational control information of one of the first and second end user communication devices by the other of the first and second end user communication devices.

7. The method as recited in claim 1, wherein the IPTV session control information includes the identification of a new IPTV session channel for the established second IPTV session, and wherein the transmitting step includes transmitting the new IPTV session channel based on the IPTV session control information.

8. The method as recited in claim 1, further comprising the step of the control server buffering at least a portion of the IPTV content from the IPTV content source, and wherein the control server is configured to transmit at least a portion of the buffered IPTV content from the control server to the second end user communication device in response to receiving IPTV session control information.

9. The method as recited in claim 1, wherein the first end user communication devices is selected from the group consisting of a set-top box, a network session controller, a signal converter box, a signal decoder box, a digital video recorder, a digital video disk recorder, a personal video recorder device, a home media server, a digital video server, a residential gateway, a video receiver, a computer.

10. The method as recited in claim 1, wherein the second end user communication devices is a mobile communication device selected from the group consisting of a cellular telephone, a smart telephone, a personal digital assistant (PDA), a Digital Video Broadcasting-Handheld (DVB-H) mobile communication device, a digital music player, a portable video player, a wireless handheld device, a digital camera, a mobile communication device, a laptop personal computer (PC), a notebook PC and a mobile computing device.

11. A control server device for providing session mobility between a first end user communication device and a second end user communication device, wherein the first end user communication device and the second end user communication device are coupled to an Internet Protocol (IP) network, wherein the first end user communication device is configured to receive Internet Protocol Television (IPTV) content from at least one IPTV content source coupled to the IP network to establish a first IPTV session, comprising:
a controller coupled to the IP network and configured to receive IPTV content from the at least one IPTV content source; and
a memory element coupled to the controller for storing at least a portion of the IPTV content and the IPTV session control information received by the controller,
wherein the controller is configured to transmit to and receive from the first end user communication device a first set of IPTV session control information, wherein the first end user communication device is configured to receive IPTV content from the at least one IPTV content source to establish a first IPTV session based on the communication of IPTV session control information between the control server and at least one of the first and second end user communication devices,
wherein the controller is configured to transmit to and receive from the second end user communication device a second set of IPTV session control information,
wherein the controller is configured to receive IPTV content from the at least one IPTV content source based on the communication of IPTV session control information between the control server and at least one of the first and second end user communication devices,
wherein the controller is configured to transmit at least a portion of the IPTV content received thereby to the second end user communication devices based on the communication of IPTV session control information between the control server and at least one of the first and second end user communication devices, wherein the transmission of IPTV content to the second end user communication device establishes a second IPTV session, and
wherein the establishment of the first IPTV session and the second IPTV session provides IPTV session mobility between the first and second end user communication devices.

12. The device as recited in claim 9, wherein the IPTV session control information includes the selection of an end user communication device to which an IPTV session is to be established.

13. The device as recited in claim 9, wherein the IPTV session control information includes at least one of an identification of an IPTV session being transmitted to an end user communication device, a current viewing position in the identified IPTV session, and an identification of an end user communication device to be provided with IPTV content to establish an IPTV session.

14. The device as recited in claim 9, wherein at least a portion of the IPTV content received by the controller is buffered in the memory element, and wherein the controller is configured to transmit at least a portion of the buffered IPTV content to the second end user communication device based on the communication of IPTV session control information between the control server and at least one of the first and second end user communication devices.

15. The device as recited in claim 11, wherein the controller is configured to discontinue the transmission of at least a portion of the IPTV content received thereby to the second end user communication device based on the communication of IPTV session control information between the control server and at least one of the first and second end user communication devices.

16. The device as recited in claim 11, wherein at least a portion of the control server device is included in at least one of the first end user communication device, the second end user communication device and the multimedia content source.

17. The device as recited in claim 11, wherein the control server device is selected from the group consisting of a network session controller, a signal converter box, a signal decoder box, a digital video recorder, a digital video disk recorder, a personal video recorder device, a home media server, a digital video server, a residential gateway, a video receiver, a computer.

18. The device as recited in claim 11, wherein the first end user communication device is selected from the group consisting of a set-top box, a network session controller, a signal converter box, a signal decoder box, a digital video recorder, a digital video disk recorder, a personal video recorder device, a home media server, a digital video server, a residential gateway, a video receiver, a computer.

19. The device as recited in claim 11, wherein the second end user communication device is a mobile communication device selected from the group consisting of a cellular telephone, a smart telephone, a personal digital assistant (PDA), a Digital Video Broadcasting-Handheld (DVB-H) mobile communication device, a digital music player, a portable video player, a wireless handheld device, a digital camera, a mobile communication device, a laptop personal computer (PC), a notebook PC and a mobile computing device.

20. A computer readable medium storing instructions that, when executed on a programmed processor, carry out a method for providing session mobility between a first end user communication device and a second end user communication device, wherein the first end user communication device and the second end user communication device are coupled to an Internet Protocol (IP) network, and wherein the first end user communication device is configured to receive Internet Protocol Television (IPTV) content from at least one IPTV content source coupled to the IP network to establish a first IPTV session, comprising:
instructions for communicating a first set of IPTV session control information between a control server coupled to the IP network and the first end user communication device, wherein the first end user communication device is configured to receive IPTV content from the IPTV content source in response to the communication of at least a portion of the first set of IPTV session control information;
instructions for communicating a second set of IPTV session control information between the control server and the second end user communication device;
instructions for receiving by the control server from the IPTV content source, in response to the communication of IPTV session control information between the control server and at least one of the first and second end user communication devices, at least a portion of the IPTV content transmitted to the first end user communication device from the IPTV content source; and
instructions for transmitting by the control server at least a portion of the IPTV content received thereby to the second end user communication device in response to the communication of IPTV session control information between the control server and at least one of the first and second end user communication devices, wherein the transmission of IPTV content to the second end user communication device establishes a second IPTV session in a manner that provides IPTV session mobility between the first and second end user communication devices.
